(19) United States
(12) Patent Application Publication
(10) Pub. No.: US 2023/0331556 A1
(43) Pub. Date: Oct. 19, 2023

(54) METHOD FOR MANUFACTURING POSITIVE ELECTRODE ACTIVE MATERIAL

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, Atsugi-shi, Kanagawa-ken (JP); Yumiko YONEDA, Isehara, Kanagawa (JP); Kazutaka KURIKI, Ebina, Kanagawa (JP)

(21) Appl. No.: 18/043,102

(22) PCT Filed: Aug. 20, 2021
(86) PCT No.: PCT/IB2021/057661

§ 371 Date: Feb. 27, 2023

(30) Foreign Application Priority Data
Sep. 4, 2020 (JP) 2020-149330

(51) Int. Cl. C01B 25/45

(52) U.S. Cl. CPC C01B 25/45; C01P 2006/80; C01P 2006/40; C01P 2004/04; C01P 2002/70

(57) ABSTRACT

A method for manufacturing a highly purified positive electrode active material is provided. Alternatively, a method for manufacturing a positive electrode active material whose crystal structure is not easily broken even when charge and discharge are repeated is provided. The method for manufacturing a positive electrode active material containing lithium and a transition metal includes a first step of preparing a lithium compound, a phosphorus compound, and water; a second step of forming a first mixture by mixing the lithium compound, the phosphorus compound, and the water; a third step of forming a second mixture by adding a first aqueous solution to the first mixture to adjust a pH; a fourth step of forming a third mixture by mixing an iron(II) compound with the second mixture; a fifth step of forming a fourth mixture by heating the third mixture; and a sixth step of obtaining a positive electrode active material by filtering, washing, and drying the fourth mixture. High-purity materials are used as the lithium compound, the phosphorus compound, the water, and the iron(II) compound.

### TECHNICAL FIELD

The present invention relates to a method for manufacturing a positive electrode active material. Alternatively, the present invention relates to a method for manufacturing a secondary battery. Alternatively, the present invention relates to an electronic device, a vehicle, and the like each including a secondary battery.

The present invention relates to an object, a method, or a manufacturing method. Alternatively, the present invention relates to a process, a machine, manufacture, or a composition of matter. In particular, one embodiment of the present invention relates to a semiconductor device, a display device, a light-emitting device, a power storage device, a memory device, a driving method thereof, a manufacturing method thereof, or an evaluation method thereof. In particular, one embodiment of the present invention relates to a power storage device and a manufacturing method thereof or an evaluation method thereof. Alternatively, the present invention relates to a composite oxide and a manufacturing method thereof. Alternatively, the present invention relates to a positive electrode active material and a manufacturing method thereof Alternatively, the present invention relates to a lithium ion battery. Alternatively, the present invention relates to a battery management unit and an electronic device.

Note that in this specification, a semiconductor device refers to any device that can function by utilizing semiconductor characteristics, and an electro-optical device, a semiconductor circuit, and an electronic device are all semiconductor devices.

Note that an electronic device in this specification refers to any device including a positive electrode active material, a secondary battery, or a power storage device; an electro-optical device including a positive electrode active material, a secondary battery, or a power storage device, an information terminal device including a power storage device, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

An example of such a power storage device includes a power storage device including an electrode using LiFePO₄ (lithium iron phosphate), which is a composite oxide, as an active material. The power storage device including the electrode using LiFePO₄ has high thermal stability and favorable cycle performance.

The solubility in a solution at high temperature and under high pressure is higher than at normal temperature and under normal pressure. Furthermore, by controlling the pH of a solution, dissolution and precipitation of a material can be controlled (Patent Document 1). An example of a reaction at high temperature and under high pressure is a hydrothermal method.

As a method for generating a composite oxide such as LiFePO₄, a hydrothermal method is used, for example (Patent Document 2).

With the use of a hydrothermal method, even a material that is less likely to be dissolved in water at normal temperature and under normal pressure can be dissolved, thereby achieving synthesis or crystal growth of a substance that is difficult to obtain by a production method at normal temperature and under normal pressure. Moreover, the use of a hydrothermal method can easily synthesize single crystal microparticles of a target substance.

In a hydrothermal method, for example, a desired compound can be generated by putting a solution containing a raw material in a pressure-resistant container, performing treatment with pressure application and heating, and then filtering the solution that has been subjected to the treatment with pressure application and heating.

### REFERENCE

### Patent Document

[Patent Document 1] PCT International Publication No. 2008/091578

[Patent Document 2] Japanese Published Patent Application No. 2004-95385

### SUMMARY OF THE INVENTION

### Problems to be Solved by the Invention

Since a positive electrode active material is a high-cost material in a lithium-ion secondary battery, higher performance (e.g., increase in capacity, improvement in cycle performance, and increase in reliability or safety) has been in high demand. In particular, one of objects for higher performance is a demand for increasing the purity of a positive electrode active material to increase the capacity.

In view of the above, an object of one embodiment of the present invention is to provide a method for manufacturing a highly purified positive electrode active material. Another object is to provide a method for manufacturing a positive electrode active material whose crystal structure is not easily broken even when charge and discharge are repeated. Another object is to provide a method for manufacturing a positive electrode active material with excellent charge and discharge cycle performance. Another object is to provide a method for manufacturing a positive electrode active material with high charge and discharge capacity. Another object is to provide a secondary battery with high reliability or safety.

Another object of one embodiment of the present invention is to provide a novel substance, novel active material particles, a novel secondary battery, a novel power storage device, or a manufacturing method thereof. Another object of one embodiment of the present invention is to provide a method for manufacturing a secondary battery having one or more characteristics selected from high purity, high performance, and high reliability or to provide the secondary battery.

Note that the description of these objects does not preclude the existence of other objects. In one embodiment of the present invention, there is no need to achieve all these objects. Other objects are apparent from and can be derived from the description of the specification, the drawings, the claims, and the like.

### Means for Solving the Problems

One embodiment of the present invention is a method for manufacturing a positive electrode active material containing lithium and a transition metal, including a first step of preparing a lithium compound, a phosphorus compound, and water; a second step of forming a first mixture by mixing the lithium compound, the phosphorus compound, and the water; a third step of forming a second mixed solution by adding a first aqueous solution to a first mixed solution to adjust a pH; a fourth step of forming a third mixed solution by mixing an iron(II) compound with the second mixed solution; a fifth step of forming a fourth mixed solution by heating the third mixed solution; and a sixth step of obtaining a composite oxide by filtering, washing, and drying the fourth mixed solution. In the first step, a material having a purity higher than or equal to 99.99% is prepared as the lithium compound, a material having a purity higher than or equal to 99% is prepared as the phosphorus compound, and pure water having a resistivity higher than or equal to 15 MΩ·cm is prepared as the water. In the fourth step, a material having a purity higher than or equal to 99.9% is used as the iron(II) compound. In the fourth step, a pH of the third mixed solution is greater than or equal to 3.5 and less than or equal to 5.0. The heating in the fifth step is performed under a pressure higher than or equal to 0.11 MPa and lower than or equal to 2 MPa at a temperature higher than or equal to 150° C. and lower than or equal to 250° C. for longer than or equal to 1 hour and shorter than or equal to 10 hours.

In the above embodiment, it is preferred that lithium chloride be used as the lithium compound, phosphoric acid be used as the phosphorus compound, and iron(II) chloride tetrahydrate be used as the iron(II) compound.

In the above embodiments, it is preferred that pure water having a resistivity higher than or equal to 15 MΩ·cm be used for the washing.

### EFFECT OF THE INVENTION

According to one embodiment of the present invention, a method for manufacturing a highly purified positive electrode active material can be provided. A method for manufacturing a positive electrode active material whose crystal structure is not easily broken even when charge and discharge are repeated can be provided. A method for manufacturing a positive electrode active material with excellent charge and discharge cycle performance can be provided. A method for manufacturing a positive electrode active material with high charge and discharge capacity can be provided. A secondary battery with high reliability or safety can be provided.

According to one embodiment of the present invention, a novel substance, novel active material particles, a novel secondary battery, a novel power storage device, or a manufacturing method thereof can be provided. According to one embodiment of the present invention, a method for manufacturing a secondary battery having one or more characteristics selected from high purity, high performance, and high reliability or the secondary battery can be provided.

Note that the description of these effects does not preclude the existence of other effects. One embodiment of the present invention does not need to have all these effects. Other effects will be apparent from and can be derived from the description of the specification, the drawings, the claims, and the like.

### BRIEF DESCRIPTION OF THE DRAWINGS

FIG. 1 is a diagram showing an example of a method for manufacturing a positive electrode active material of one embodiment of the present invention.

FIG. 2 is a diagram showing an example of a method for manufacturing a positive electrode active material of one embodiment of the present invention.

FIG. 3A and FIG. 3B are cross-sectional views of an active material layer in the case where a graphene compound is used as a conductive additive.

FIG. 4A and FIG. 4B are diagrams illustrating examples of a secondary battery.

FIG. 5A to FIG. 5C are diagrams illustrating an example of a secondary battery.

FIG. 6A and FIG. 6B are diagrams illustrating an example of a secondary battery.

FIG. 7A to FIG. 7C are diagrams illustrating a coin-type secondary battery.

FIG. 8A to FIG. 8D are diagrams illustrating cylindrical secondary batteries.

FIG. 9A and FIG. 9B are diagrams illustrating an example of a secondary battery.

FIG. 10A to FIG. 10D are diagrams illustrating examples of a secondary battery.

FIG. 11A and FIG. 11B are diagrams illustrating examples of a secondary battery.

FIG. 12 is a diagram illustrating an example of a secondary battery.

FIG. 13A to FIG. 13C are diagrams illustrating a laminated secondary battery.

FIG. 14A and FIG. 14B are diagrams illustrating a laminated secondary battery.

FIG. 15 is a diagram illustrating the appearance of a secondary battery.

FIG. 16 is a diagram illustrating the appearance of a secondary battery.

FIG. 17A to FIG. 17C are diagrams illustrating a method for manufacturing a secondary battery.

FIG. 18A to FIG. 18E are diagrams illustrating a bendable secondary battery.

FIG. 19A and FIG. 19B are diagrams illustrating a bendable secondary battery.

FIG. 20 is a diagram illustrating examples of electronic devices.

FIG. 21A to FIG. 21C are diagrams illustrating examples of vehicles.

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

In this specification and the like, a secondary battery having characteristics of high purity means that a material of one or more selected at least from a positive electrode, a negative electrode, a separator, and an electrolyte has high purity. A highly purified positive electrode active material means that a material included in the positive electrode active material has high purity. Regarding the purity of a material that can be used as the material of the positive electrode active material of one embodiment of the present invention, for example, the purity of Li₂CO₃ is higher than or equal to 3N (99.9%), preferably higher than or equal to 4N (99.99%), further preferably higher than or equal to 4N5 (99.995%), still further preferably higher than or equal to 5N (99.999%). The purity of LiCl is higher than or equal to 3N (99.9%), preferably higher than or equal to 4N (99.99%), further preferably higher than or equal to 4N5 (99.995%), still further preferably higher than or equal to 5N (99.999%). The purity of NH₄H₂PO₄ is higher than or equal to 2N (99%), preferably higher than or equal to 3N (99.9%), further preferably higher than or equal to 4N (99.99%), still further preferably higher than or equal to 4N5 (99.995%). The purity of FeCl is higher than or equal to 3N (99.9%), preferably higher than or equal to 4N (99.99%), further preferably higher than or equal to 4N5 (99.995%), still further preferably higher than or equal to 5N (99.999%). In the case of H₃PO₄, the content of impurity elements other than H, P, and O in an aqueous solution is less than 1%, preferably less than 0.1%, further preferably less than 0.01%, still further preferably less than 0.005%. In other words, the purity of H₃PO₄ is higher than or equal to 2N (99%), preferably higher than or equal to 3N (99.9%), further preferably higher than or equal to 4N (99.99%), still further preferably higher than or equal to 4N5 (99.995%).

### Embodiment 1

In this embodiment, a method for manufacturing a positive electrode active material of one embodiment of the present invention is described.

### Method for Manufacturing Positive Electrode Active Material

The positive electrode active material of one embodiment of the present invention is manufactured using a liquid phase method, preferably a hydrothermal method.

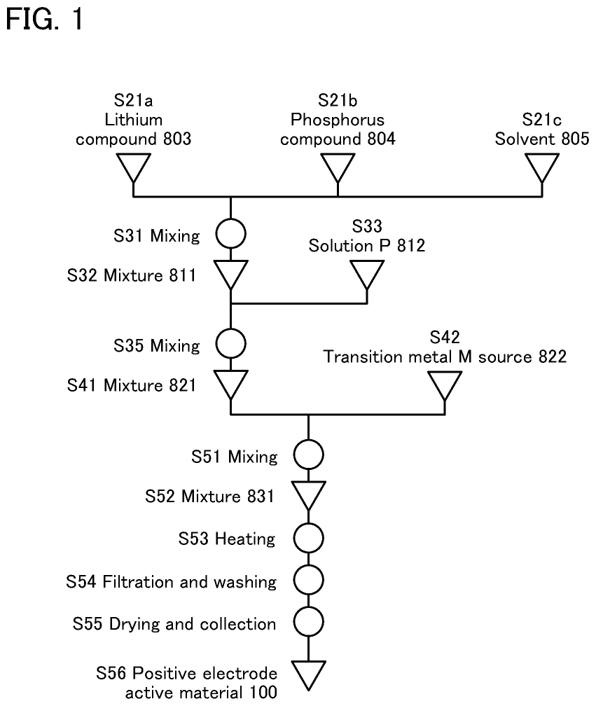

A method for manufacturing a positive electrode active material of one embodiment of the present invention is described using FIG. 1.

In Step S21a, a lithium compound 803 is prepared. In Step S21b, a phosphorus compound 804 is prepared.

Here, the atomic ratio of lithium to a transition metal M and phosphorus of a composite oxide that is preferably obtained as an after-mentioned positive electrode active material 100 is x:y:z. In order to obtain LiMPO₄, for example, x:y:z=1:1:1 is satisfied.

Typical examples of the lithium compound include lithium chloride (LiCl), lithium acetate (CH₃COOLi), lithium oxalate ((COOLi)₂), lithium carbonate (Li₂CO₃), and lithium hydroxide monohydrate (LiOH·H₂O).

Typical examples of the phosphorus compound include phosphoric acid such as orthophosphoric acid (H₃PO₄), and ammonium hydrogen phosphate such as diammonium hydrogen phosphate ((NH₄)₂HPO₄) and ammonium dihydrogen phosphate (NH₄H₂PO₄).

Next, in Step S21c, a solvent 805 is prepared. Water is preferably used as the solvent 805. Alternatively, a mixed solution of water and another liquid may be used as the solvent 805. For example, water and alcohol may be mixed. Here, the lithium compound 803 and the phosphorus compound 804 or a reaction product of the lithium compound 803 and the phosphorus compound 804 may have different solubilities in water and alcohol. Using alcohol makes the grain size of formed particles smaller in some cases. Furthermore, by using alcohol, which has a lower boiling point than water, pressure can be easily increased in some cases in Step S53 described later.

Note that in the case where water is used as the solvent 805, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

Next, in Step S31, the lithium compound 803, the phosphorus compound 804, and the solvent 805 are mixed, whereby a mixture 811 of Step S32 is obtained. The mixing in Step S31 can be performed in an atmosphere of air, an inert gas, or the like. As the inert gas, nitrogen is used, for example. Here, as an example, the lithium compound 803 prepared in Step S21a, the phosphorus compound 804 prepared in Step S21b, and the solvent 805 prepared in Step S21c are mixed in an air atmosphere. For example, the lithium compound 803 prepared in Step S21a and the phosphorus compound 804 prepared in Step S21b are put in the solvent 805 prepared in Step S21c, whereby the mixture 811 of Step S32 is formed.

In the mixture 811 of Step S32, the lithium compound 803, the phosphorus compound 804, and the reaction product of the lithium compound 803 and the phosphorus compound 804 are precipitated in the mixture 811 in some cases; however, they are partly dissolved in the solvent without being precipitated, i.e., they partly exist as ions in the mixture 811. Here, when the mixture 811 has a low pH, the reaction product and the like may be easily dissolved in the solvent; when the mixture 811 has a high pH, the reaction product and the like may be easily precipitated.

Note that instead of forming the mixture 811 of Step S32 by mixing the lithium compound 803 and the phosphorus compound 804, the mixture 811 of Step S32 may be formed by preparing a compound containing phosphorus and lithium, such as Li₃PO₄, Li₂HPO₄, or LiH₂PO₄, and adding the compound to a solvent.

Here, in the case where the mixture 811 of Step S32 is an aqueous solution, the pH of the mixture 811 depends on the kind and dissociation degree of the salt included in the mixture 811. Accordingly, the pH of the mixture 811 changes depending on the lithium compound 803 and the phosphorus compound 804 used as the source materials. For example, in the case of using lithium chloride as the lithium compound 803 and orthophosphoric acid as the phosphorus compound 804, the mixture 811 of Step S32 is likely to be a strong acid. As another example, in the case of using lithium hydroxide monohydrate as the lithium compound 803, the mixture 811 of Step S32 is likely to be alkaline.

Next, in Step S33, a solution P 812 is prepared. Then, in Step S35, the mixture 811 of Step S32 and the solution P 812 prepared in Step S33 are mixed, whereby a mixture 821 of Step S41 is formed. Here, by adjusting the amount or concentration of the solution P 812 to be added, the pH of the obtained mixture 821 of Step S41 and a subsequently obtained mixture 831 of Step S52 can be adjusted. In Step S35, for example, the solution P 812 is dropped while the pH of the mixture 811 of Step S32 is measured. As the solution P 812, an alkaline solution or an acidic solution is used in accordance with the pH of the mixture 811 of Step S32. Here, by using a slightly alkaline or slightly acidic solution, the pH is easily adjusted in some cases. For example, the pH of the alkaline solution is greater than or equal to 8 and less than or equal to 12. Furthermore, the pH of the acidic solution is greater than or equal to 2 and less than or equal to 6. As the alkaline solution, ammonia water is used, for example. The pH and mixed amount of the solution P 812 are preferably determined so that the mixture 831 of Step S52, which is described later, becomes acidic or neutral.

Next, in Step S42, a transition metal M source 822 is prepared. As the transition metal M source 822, one or more of an iron(II) compound, a manganese(II) compound, a cobalt(II) compound, and a nickel(II) compound (hereinafter referred to as an M(II) compound) can be used.

Note that a high-purity material is preferably used as the transition metal M source used for the synthesis. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a secondary battery and/or increase the reliability of a secondary battery.

In addition, it is preferred that the transition metal M source here have high crystallinity. For example, the transition metal M source preferably includes single crystal grains. To evaluate the crystallinity of the transition metal M source, for example, the crystallinity can be judged by a TEM (transmission electron microscope) image, an STEM (scanning transmission electron microscope) image, a HAADF-STEM (high-angle annular dark field scanning transmission electron microscope) image, an ABF-STEM (annular bright-field scan transmission electron microscope) image, and the like. For evaluation of the crystallinity of the transition metal M source, X-ray diffraction (XRD), electron diffraction, neutron diffraction, and the like can also be used for judging. Note that the above-described crystallinity evaluation can be applied not only to the transition metal M source but also to a primary particle or a secondary particle.

Typical examples of the iron(II) compound include iron chloride tetrahydrate (FeCl₂·4H₂O), iron sulfate heptahydrate (FeSO₄·7H₂O), and iron acetate (Fe(CH₃COO)₂).

Typical examples of the manganese(II) compound include manganese chloride tetrahydrate (MnCl₂·4H₂O), manganese sulfate monohydrate (MnSO₄H₂O), and manganese acetate tetrahydrate (Mn(CH₃COO)₂·4H₂O).

Typical examples of the cobalt(II) compound include cobalt chloride hexahydrate (CoCl₂·6H₂O), cobalt sulfate heptahydrate (CoSO₄·7H₂O), and cobalt acetate tetrahydrate (Co(CH₃COO)₂·4H₂O).

Typical examples of the nickel(II) compound include nickel chloride hexahydrate (NiCl₂·6H₂O), nickel sulfate hexahydrate (NiSO₄·6H₂O), and nickel acetate tetrahydrate (Ni(CH₃COO)₂·4H₂O).

Note that in Step S42, an aqueous solution of any of the above compounds may be prepared as the transition metal M source 822. In the case of preparing an aqueous solution of the compound, water to be used is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher.

Next, in Step S51, the mixture 821 of Step S41 and the transition metal M source 822 are mixed, whereby the mixture 831 of Step S52 is obtained.

Here, in Step S51, the concentration of the mixture 831 of Step S52 can be reduced by addition of a solvent. For example, in Step S51, the mixture 821 of Step S41, the transition metal M source 822, and a solvent are mixed, whereby the mixture 831 of Step S52 can be manufactured.

Next, in Step S53, the mixture 831 of Step S52 is put into a heat- and pressure-resistant container such as an autoclave; then, heating is performed at a temperature higher than or equal to 100° C. and lower than or equal to 350° C., preferably higher than 100° C. and lower than 200° C. under a pressure higher than or equal to 0.11 MPa and lower than or equal to 100 MPa, preferably higher than or equal to 0.11 MPa and lower than or equal to 2 MPa for longer than or equal to 0.5 hours and shorter than or equal to 24 hours, preferably longer than or equal to 1 hour and shorter than or equal to 10 hours, further preferably longer than or equal to 1 hour and shorter than 5 hours; after that, cooling is performed. Then, in Step S54, the solution in the heat- and pressure-resistant container is filtered, followed by washing with water. Next, in Step S55, drying and subsequent collection are performed, whereby the positive electrode active material 100 of Step S56 is obtained.

Note that the water used in Step S54 is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The washing with high-purity pure water makes it possible to obtain the high-purity positive electrode active material 100, and can increase the capacity of a secondary battery and/or increase the reliability of a secondary battery.

Here, a composite oxide, for example, LiMPO₄ (M is one or more of Fe(II), Ni(II), Co(II), and Mn(II)) is preferably obtained as the positive electrode active material 100. Depending on the kind of the M(II) compound, any of the following is obtained as appropriate, for example: LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}NiₐMnₑPO₄, LiNi_{c}Co_{d}MnₑPO₄ (c+d+e is 1 or less, 0<c<1, 0<d<1, and 0<e<1), and LiFeⱼNi_{g}CoₕMnᵢPO₄ (f+g+h+i is 1 or less, 0<f<1, 0<g<1, 0<h<1, and 0<i<1). The composite oxide obtained according to this embodiment may be a single crystal grain.

By performing crystal analysis such as XRD or electron diffraction, for example, on the positive electrode active material 100, the crystal structure can be identified. By performing crystal analysis on the positive electrode active material 100, a crystal structure belonging to a space group Pnma can be obtained in some cases. Here, LiMPO₄ having an olivine crystal structure belongs to the space group Pnma, for example.

As described above, in one embodiment of the present invention, high-purity materials are used as raw materials used in the synthesis, and a positive electrode active material is manufactured in a process where impurities are less likely to be mixed during the synthesis. The positive electrode active material obtained by such a method for manufacturing a positive electrode active material is a material having a low impurity concentration, that is, a highly purified material. Moreover, the positive electrode active material obtained by such a method for manufacturing a positive electrode active material is a material having high crystallinity. With the positive electrode active material obtained by the method for manufacturing the positive electrode active material of one embodiment of the present invention, the capacity of a secondary battery can be increased and/or the reliability of a secondary battery can be increased.

This embodiment can be used in appropriate combination with any of the other embodiments.

### Embodiment 2

In this embodiment, a method for manufacturing a positive electrode active material of one embodiment of the present invention is described.

### Method for Manufacturing Positive Electrode Active Material

The positive electrode active material of one embodiment of the present invention is manufactured using a liquid phase method, preferably a hydrothermal method.

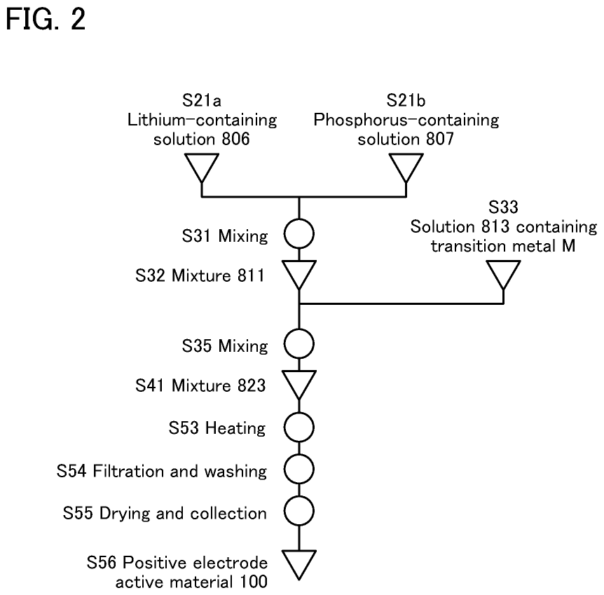

A method for manufacturing a positive electrode active material of one embodiment of the present invention is described using FIG. 2.

In Step S21a, a lithium-containing solution 806 is prepared. In Step S21b, a phosphorus-containing solution 807 is prepared.

The lithium-containing solution 806 can be formed by dissolving a lithium compound in a solvent. As the lithium compound, any one or more of lithium hydroxide monohydrate (LiOH·H₂O), lithium chloride (LiCl), lithium carbonate (Li₂CO₃), lithium acetate (CH₃COOLi), and lithium oxalate ((COOLi)₂) can be used. Water can be used as the solvent in which the lithium compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

The phosphorus-containing solution 807 can be formed by dissolving a phosphorus compound in a solvent. As the phosphorus compound, any one or more of phosphoric acid such as orthophosphoric acid (H₃PO₄) and ammonium hydrogen phosphate such as diammonium hydrogen phosphate ((NH₄)₂HPO₄) and ammonium dihydrogen phosphate (NH₄H₂PO₄) can be used. Water can be used as the solvent in which the phosphorus compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

Next, in Step S31, the lithium-containing solution 806 and the phosphorus-containing solution 807 are mixed, whereby the mixture 811 of Step S32 is obtained. The mixing in Step S31 can be performed in an atmosphere of air, an inert gas, or the like. As the inert gas, nitrogen is used, for example. Here, as an example, the lithium-containing solution 806 prepared in Step S21a and the phosphorus-containing solution 807 prepared in Step S21b are mixed in an air atmosphere.

Note that instead of forming the mixture 811 of Step S32 by mixing the lithium-containing solution 806 and the phosphorus-containing solution 807, the mixture 811 of Step S32 may be formed by preparing a compound containing phosphorus and lithium, such as Li₃PO, Li₂HPO₄, or LiH₂PO₄, and adding the compound to a solvent.

Next, in Step S33, a solution 813 containing the transition metal M is prepared.

The solution 813 containing the transition metal M can be formed by dissolving a transition metal M compound in a solvent. As the transition metal M compound, one or more of an iron(II) compound, a manganese(II) compound, a cobalt(II) compound, and a nickel(II) compound (hereinafter referred to as an M(II) compound) can be used. Water can be used as the solvent in which the transition metal M compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material 0 can increase the capacity of a secondary battery and/or increase the reliability of a secondary battery.

Note that a high-purity material is preferably used as the transition metal M compound used for the synthesis. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a secondary battery and/or increase the reliability of a secondary battery.

In addition, it is preferred that the transition metal M compound here have high crystallinity. For example, the transition metal compound preferably includes single crystal grains. To evaluate the crystallinity of the transition metal compound, for example, the crystallinity can be judged by a TEM (transmission electron microscope) image, an STEM (scanning transmission electron microscope) image, a HAADF-STEM (high-angle annular dark field scanning transmission electron microscope) image, an ABF-STEM (annular bright-field scan transmission electron microscope) image, and the like. For evaluation of the crystallinity of the transition metal M compound, X-ray diffraction (XRD), electron diffraction, neutron diffraction, and the like can also be used for judging. Note that the above-described crystallinity evaluation can be applied not only to the transition metal M compound but also to a primary particle or a secondary particle.

Typical examples of the iron(II) compound include iron chloride tetrahydrate (FeCl₂·4H₂O), iron sulfate heptahydrate (FeSO₄·7H₂O), and iron acetate (Fe(CH₃COO)₂).

Typical examples of the manganese(II) compound include manganese chloride tetrahydrate (MnCl₂·4H₂O), manganese sulfate monohydrate (MnSO₄H₂O), and manganese acetate tetrahydrate (Mn(CH₃COO)₂·4H₂O).

Typical examples of the cobalt(II) compound include cobalt chloride hexahydrate (CoCl₂·6H₂O), cobalt sulfate heptahydrate (CoSO₄·7H₂O), and cobalt acetate tetrahydrate (Co(CH₃COO)₂·4H₂O).

Typical examples of the nickel(II) compound include nickel chloride hexahydrate (NiCl₂·6H₂O), nickel sulfate hexahydrate (NiSO₄·6H₂O), and nickel acetate tetrahydrate (Ni(CH₃COO)₂·4H₂O).

Next, in Step 35, the mixture 811 of Step S32 and the solution 813 containing the transition metal M are mixed, whereby a mixture 823 of Step S41 is obtained.

Here, the atomic ratio of lithium to the transition metal M and phosphorus of the composite oxide preferably obtained as the positive electrode active material 100 described later is x:y:z. In order to obtain LiMPO₄, for example, x:y:z=1:1:1 is satisfied.

In a method for the mixing in Step S35, the solution 813 containing the transition metal M is dropped little by little into the mixture 811 of Step S32 that is put in a container, whereby the mixture 823 of Step S41 can be manufactured. In the mixing, it is preferred that the solution in the container and the solution used for the mixing be being stirred, and it is also preferred that dissolved oxygen be removed by N2 bubbling.

Alternatively, in a method for the mixing in Step S35, the mixture 811 of Step S32 is dropped little by little into the solution 813 containing the transition metal M that is put in a container, whereby the mixture 823 of Step S41 can be manufactured. In the mixing, it is preferred that the solution in the container and the solution used for the mixing be being stirred, and it is also preferred that dissolved oxygen be removed by N2 bubbling.

Here, in Step S35, the concentration of the mixture 823 of Step S41 can be adjusted by addition of a solvent. For example, in Step S35, the mixture 811 of Step S32, the solution 813 containing the transition metal M, and a solvent are mixed, whereby the mixture 823 of Step S41 can be manufactured. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher.

Next, in Step S53, the mixture 823 of Step S41 is put into a heat- and pressure-resistant container such as an autoclave; then, heating is performed at a temperature higher than or equal to 100° C. and lower than or equal to 350° C., preferably higher than 100° C. and lower than 200° C. under a pressure higher than or equal to 0.11 MPa and lower than or equal to 100 MPa, preferably higher than or equal to 0.11 MPa and lower than or equal to 2 MPa for longer than or equal to 0.5 hours and shorter than or equal to 24 hours, preferably longer than or equal to 1 hour and shorter than or equal to 10 hours, further preferably longer than or equal to 1 hour and shorter than 5 hours; after that, cooling is performed. Then, in Step S54, the solution in the heat- and pressure-resistant container is filtered, followed by washing with water. Next, in Step S55, drying and subsequent collection are performed, whereby the positive electrode active material 100 of Step S56 is obtained.

Note that the water used in Step S54 is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The washing with high-purity pure water makes it possible to obtain the high-purity positive electrode active material 100, and can increase the capacity of a secondary battery and/or increase the reliability of a secondary battery.

Here, a composite oxide, for example, LiMPO₄ (M is one or more of Fe(II), Ni(II), Co(II), and Mn(II)) is preferably obtained as the positive electrode active material 100. Depending on the kind of the M(II) compound, any of the following is obtained as appropriate, for example: LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFeⱼNi_{g}CoₕMnᵢPO₄ (f+g+h+i is 1 or less, 0<f<1, 0<g<1, 0<h<1, and 0<i<1). The composite oxide obtained according to this embodiment may be a single crystal grain.

By performing crystal analysis such as XRD or electron diffraction, for example, on the positive electrode active material 100, the crystal structure can be identified. By performing crystal analysis on the positive electrode active material 100, a crystal structure belonging to a space group Pnma can be obtained in some cases. Here, LiMPO₄ having an olivine crystal structure belongs to the space group Pnma, for example.

As described above, in one embodiment of the present invention, high-purity materials are used as raw materials used in the synthesis, and a positive electrode active material is manufactured in a process where impurities are less likely to be mixed during the synthesis. The positive electrode active material obtained by such a method for manufacturing a positive electrode active material is a material having a low impurity concentration, that is, a highly purified material. Moreover, the positive electrode active material obtained by such a method for manufacturing a positive electrode active material is a material having high crystallinity. With the positive electrode active material obtained by the method for manufacturing the positive electrode active material of one embodiment of the present invention, the capacity of a secondary battery can be increased and/or the reliability of a secondary battery can be increased.

This embodiment can be used in appropriate combination with any of the other embodiments.

### Embodiment 3

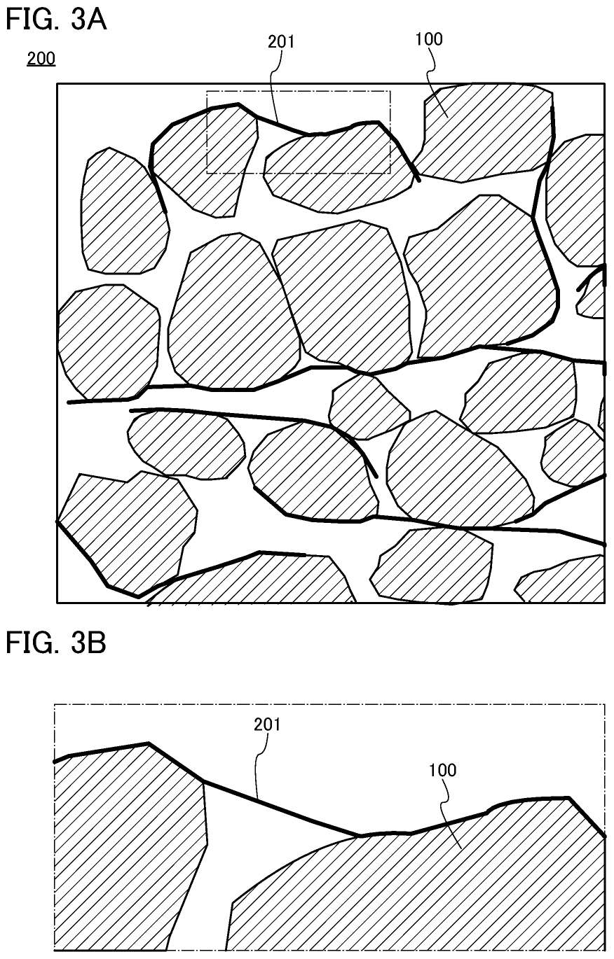

In this embodiment, examples of a secondary battery of one embodiment of the present invention are described using FIG. 3 to FIG. 6.

### <Structure Example 1 of Secondary Battery>

Hereinafter, a secondary battery in which a positive electrode, a negative electrode, and and electrolyte are wrapped in an exterior body is described as an example.

### Positive Electrode

The positive electrode includes a positive electrode active material layer and a positive electrode current collector. The positive electrode active material layer includes a positive electrode active material, and may include a conductive additive and a binder. As the positive electrode active material, any one or more of the positive electrode active materials 100 manufactured by the manufacturing methods described in the above embodiments can be used.

The positive electrode active material 100 described in the above embodiments and another positive electrode active material may be mixed to be used.

As another positive electrode active material, it is preferable to mix lithium nickel oxide (LiNiO₂ and/or LiNi₁₋ₓMₓO₂ (0<x<1) (M=Co, Al, or the like)) with a lithium-containing material that has a spinel crystal structure and contains manganese, such as LiMn₂O₄. This composition can improve the performance of the secondary battery.

As another positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, and is further preferably nickel. In the case where the whole particles of a lithium-manganese composite oxide are measured, it is preferable to satisfy the following at the time of discharging: 0<a/(b+c)<2; c>0; and 0.26 (b+c)/d<0.5. Note that the proportions of metals, silicon, phosphorus, and the like in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICPMS combined with fusion gas analysis and valence evaluation of XAFS (X-ray absorption fine structure) analysis. Note that a lithium-manganese composite oxide is an oxide containing at least lithium and manganese, and may contain at least one kind of element selected from chromium, cobalt, aluminum, nickel, iron, magnesium, molybdenum, zinc, indium, gallium, copper, titanium, niobium, silicon, phosphorus, and the like.

A cross-sectional structure example of an active material layer 200 using a graphene compound as a conductive additive is described below.

FIG. 3A is a longitudinal cross-sectional view of the active material layer 200. The active material layer 200 includes particles of the positive electrode active material 100, a graphene compound 201 serving as a conductive additive, and a binder (not illustrated).

The graphene compound 201 in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. The graphene compound 201 contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. The graphene compound 201 may include a functional group. The graphene compound 201 preferably has a bent shape. The graphene compound 201 may be rounded like carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive additive having high conductivity even with a small amount. In addition, the intensity ratio G/D of a G band to a D band of the Raman spectrum of the reduced oxide graphene oxide is preferably 1 or more. The reduced graphene oxide with such an intensity ratio can function as a conductive additive having high conductivity even with a small amount.

Reducing graphene oxide can form a vacancy in the graphene compound 201 in some cases.

A material obtained by terminating an end portion of the graphene compound 201 with fluorine may be used.

The graphene compound 201 preferably includes a vacancy in part of a carbon sheet. When a vacancy through which carrier ions such as lithium ions can pass is provided in part of the carbon sheet of the graphene compound 201, insertion and extraction of carrier ions are facilitated on the surface of an active material covered with the graphene compound 201, thereby increasing the rate performance of a secondary battery. The vacancy provided in part of the carbon sheet is referred to as a pore, a defect, or a gap in some cases.

The graphene compound 201 preferably includes a vacancy formed with a plurality of carbon atoms. The plurality of carbon atoms are preferably bonded to each other in a ring, and one or more of the plurality of carbon atoms bonded to each other in a ring are preferably terminated by a fluorine atom. Fluorine has high electronegativity and is easily negatively charged. Approach of positively-charged lithium ions causes interaction, whereby energy is stable and the barrier energy in passage of lithium ions through a vacancy can be lowered. Thus, a fluorine atom contained in a vacancy in the graphene compound 201 makes it possible to obtain the graphene compound 201 having excellent conductivity in which a lithium ion passes easily through even a small vacancy.

The longitudinal cross section of the active material layer 200 in FIG. 3A shows substantially uniform dispersion of the sheet-like graphene compounds 201 in the active material layer 200. The graphene compounds 201 are schematically shown by thick lines in FIG. 3A and FIG. 3B but are actually thin films with a thickness corresponding to the thickness of a single layer or a multi-layer of carbon molecules. The plurality of graphene compounds 201 are formed to partly coat or adhere to the surfaces of the plurality of particles of the positive electrode active material 100, so that the plurality of graphene compounds 201 make surface contact with the particles of the positive electrode active material 100.

Here, the plurality of graphene compounds can be bonded to each other to form a net-like graphene compound sheet (hereinafter referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume and/or the electrode weight. That is, the capacity of the secondary battery can be increased.

Here, it is preferable to perform reduction after a layer to be the active material layer 200 is formed in such a manner that graphene oxide is used as the graphene compound 201 and mixed with an active material. That is, the formed active material layer preferably contains reduced graphene oxide. When graphene oxide with extremely high dispersibility in a polar solvent is used for the formation of the graphene compound 201, the graphene compound 201 can be substantially uniformly dispersed in the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conductive path. Note that graphene oxide may be reduced by heat treatment or with the use of a reducing agent, for example.

Unlike conductive additive particles that make point contact with an active material, such as acetylene black, the graphene compound 201 is capable of making low-contact-resistance surface contact; accordingly, the electric conduction between the particles of the positive electrode active material 100 and the graphene compounds 201 can be improved with a smaller amount of the graphene compound 201 than that of a normal conductive additive. Thus, the proportion of the positive electrode active material 100 in the active material layer 200 can be increased. Hence, the discharge capacity of the secondary battery can be increased.

With a spray dry apparatus, a graphene compound serving as a conductive additive can be formed in advance as a coating film to cover the entire surface of the active material, and a conductive path can be formed between the active materials using the graphene compound.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide or the like can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferred that such water-soluble polymers be used in combination with any of the above-described rubber materials.

Alternatively, as the binder, it is preferable to use a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose.

Two or more of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, it is possible to use the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, or starch.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer stabilizes the viscosity by being dissolved in water and allows stable dispersion of the active material or another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers the active material surface or is in contact with the surface forms a film, the film is expected to serve also as a passivation film to inhibit the decomposition of an electrolyte. Here, a passivation film refers to a film without electric conductivity or a film with extremely low electric conductivity, and can inhibit the decomposition of an electrolyte at a battery reaction potential when the passivation film is formed on the active material surface, for example. It is preferred that the passivation film can conduct lithium ions while suppressing electrical conduction.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not dissolve at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### Negative Electrode

The negative electrode includes a negative electrode active material layer and a negative electrode current collector. The negative electrode active material layer may contain a conductive additive and a binder.

### Negative Electrode Active Material

As the negative electrode active material, for example, an alloy-based material and/or a carbon-based material can be used.

As the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

As the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those for the conductive additive and the binder that can be included in the positive electrode active material layer can be used.

### Negative Electrode Current Collector

For the negative electrode current collector, a material similar to that of the positive electrode current collector can be used. Note that a material that is not alloyed with carrier ions of lithium or the like is preferably used for the negative electrode current collector.

### Electrolyte

As one mode of the electrolyte, an electrolyte solution containing a solvent and an electrolyte dissolved in the solvent can be used. As the solvent of the electrolyte solution, an aprotic organic solvent is preferable. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

The use of one or more ionic liquids (room temperature molten salts) that are unlikely to burn and volatize as the solvent of the electrolyte solution can prevent a secondary battery from exploding or catching fire even when the secondary battery internally shorts out and/or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and/or aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte solution used for a secondary battery is preferably highly purified and contains a small number of dust particles and/or elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%. Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

As the polymer, it is possible to use, for example, a polymer having a polyalkylene oxide structure, such as polyethylene oxide (PEO); PVDF; polyacrylonitrile; and/or a copolymer containing any of them. For example, PVDF-HFP, which is a copolymer of PVDF and hexafluoropropylene (HFP), can be used. The formed polymer may be porous.

As the electrolyte, a solid electrolyte including an inorganic material such as a sulfide-based or oxide-based inorganic material, or a solid electrolyte including a polymer material such as a PEO (polyethylene oxide)-based polymer material can alternatively be used. When the solid electrolyte is used, a separator and/or a spacer are not necessary. Furthermore, the battery can be entirely solidified; therefore, there is no possibility of liquid leakage and thus the safety of the battery is dramatically improved.

### Separator

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### Exterior Body

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

### <Structure Example 2 of Secondary Battery>

A structure of a secondary battery including a solid electrolyte layer is described below as another structure example of a secondary battery.

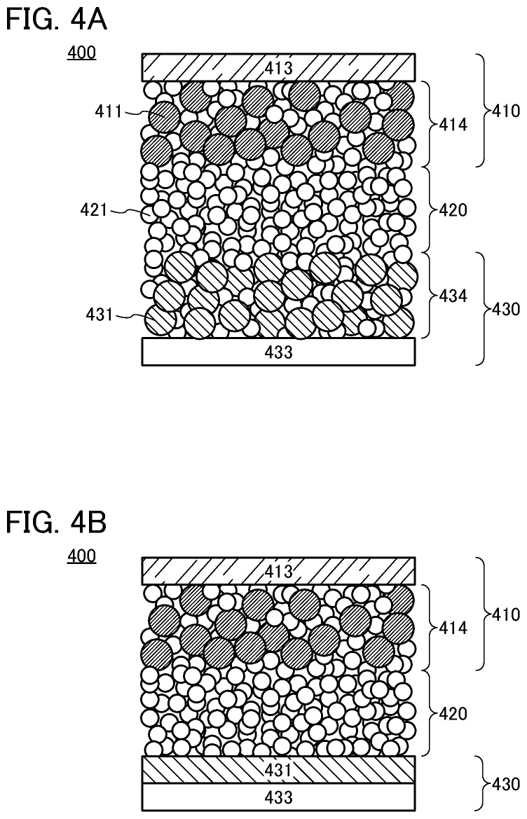

As illustrated in FIG. 4A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the manufacturing method described in the above embodiments is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metal lithium is used for the negative electrode 430, the negative electrode 430 that does not include the solid electrolyte 421 can be formed, as illustrated in FIG. 4B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}Po_{0.95}S₄). The sulfide-based solid electrolyte has advantages such as high conductivity of some materials, low-temperature synthesis, and ease of maintaining a path for electrical conduction after charging and discharging because of its relative softness. Note that the sulfide-based solid electrolyte may generate hydrogen sulfide by a reaction with water. Therefore, diligent attention to safety is required. For example, in order to improve the safety, the hermeticity of an exterior body included in the secondary battery and/or a housing in which the secondary battery is held is preferably high.

Examples of the oxide-based solid electrolyte include a material with a perovskite crystal structure (e.g., La_{2/3-x}Li₃ₓTiO₃), a material with a NASICON crystal structure (e.g., Li₁₊ₓAlₓTi₂₋ₓPO₄)₃), a material with a garnet crystal structure (e.g., Li₇La₃Zr₂O₁₂), a material with a LISICON crystal structure (e.g., Li₁₄ZnGe₄O₁₆), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air. Note that in this specification and the like, a material with a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

### Exterior Body and Shape of Secondary Battery

An exterior body of the secondary battery 400 of one embodiment of the present invention can employ a variety of materials and shapes, and preferably has a function of applying pressure to the positive electrode, the solid electrolyte layer, and the negative electrode.

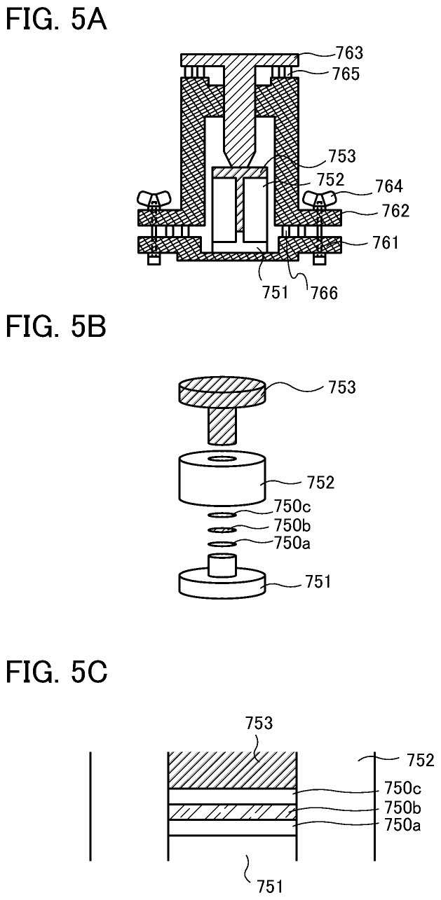

FIG. 5 shows an example of a cell for evaluating materials of an all-solid-state battery.

FIG. 5A is a schematic cross-sectional view of the evaluation cell. The evaluation cell includes a lower component 761, an upper component 762, and a fixation screw and/or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 5B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 5C. Note that the same portions in FIG. 5A, FIG. 5B, and FIG. 5C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

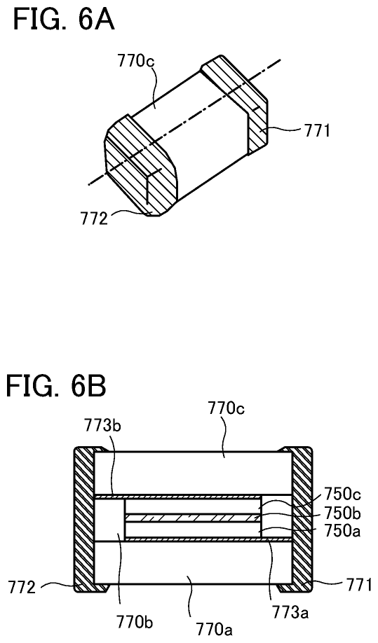

FIG. 6A is a perspective view of a secondary battery of one embodiment of the present invention that has an exterior body and a shape different from those in FIG. 5. The secondary battery in FIG. 6A includes external electrodes 771 and 772 and is sealed with an exterior body including a plurality of package components.

FIG. 6B illustrates an example of a cross section along the dashed-dotted line in FIG. 6A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material or ceramics, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be used in appropriate combination with any of the other embodiments.

### Embodiment 4

In this embodiment, examples of a shape of a secondary battery including the positive electrode described in the above embodiment are described. For the materials used for the secondary battery described in this embodiment, the description of the above embodiment can be referred to.

### <Coin-Type Secondary Battery>

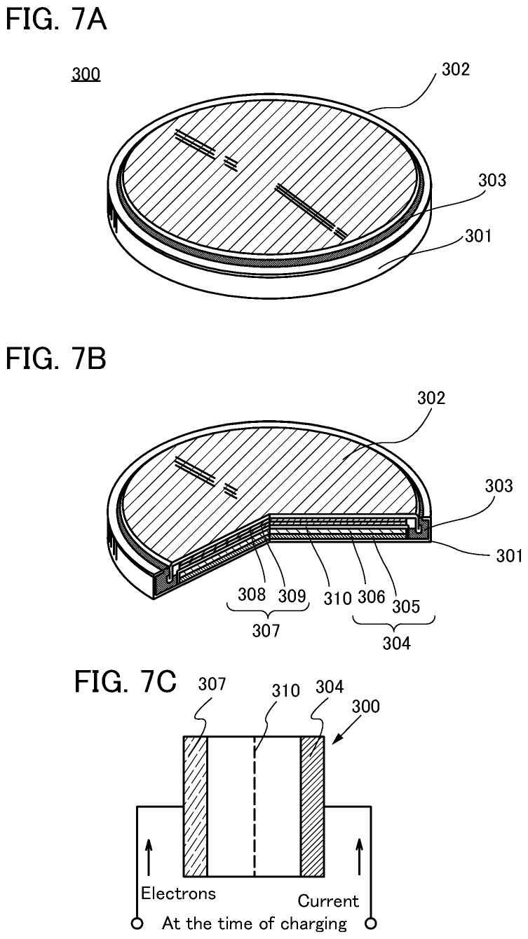

First, an example of a coin-type secondary battery is described. FIG. 7A is an external view of a coin-type (single-layer flat type) secondary battery, and FIG. 7B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, and/or the like in order to prevent corrosion due to the electrolyte.

The positive electrode can 301 and the negative electrode can 302 are electrically connected to the positive electrode 304 and the negative electrode 307, respectively.

The negative electrode 307, the positive electrode 304, and a separator 310 are immersed in the electrolyte. Then, as illustrated in FIG. 7B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin secondary battery 300 is manufactured.

When the positive electrode active material described in the above embodiment is used in the positive electrode 304, the coin-type secondary battery 300 with high capacity and excellent cycle performance can be obtained.

Here, a current flow in charging a secondary battery is described using FIG. 7C. When a secondary battery using lithium is regarded as a closed circuit, movement of lithium ions and the current flow are in the same direction. Note that in the secondary battery using lithium, the anode and the cathode interchange in charge and discharge, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “+electrode (plus electrode)” and the negative electrode is referred to as a “negative electrode” or a “−electrode (minus electrode)” in all the cases where charge is performed, discharge is performed, a reverse pulse current is made to flow, and a charging current is made to flow. The use of the term “anode” or “cathode” related to an oxidation reaction or a reduction reaction might cause confusion because the anode and the cathode interchange in charge and discharge. Thus, the term “anode” or “cathode” is not used in this specification. If the term “anode” or “cathode” is used, it should be mentioned that the anode or the cathode is which of the one at the time of charge or the one at the time of discharge and corresponds to which of a positive electrode (plus electrode) or a negative electrode (minus electrode).

Two terminals illustrated in FIG. 7C are connected to a charger, and the secondary battery 300 is charged. As the charge of the secondary battery 300 proceeds, a potential difference between the electrodes increases.

### <Cylindrical Secondary Battery>

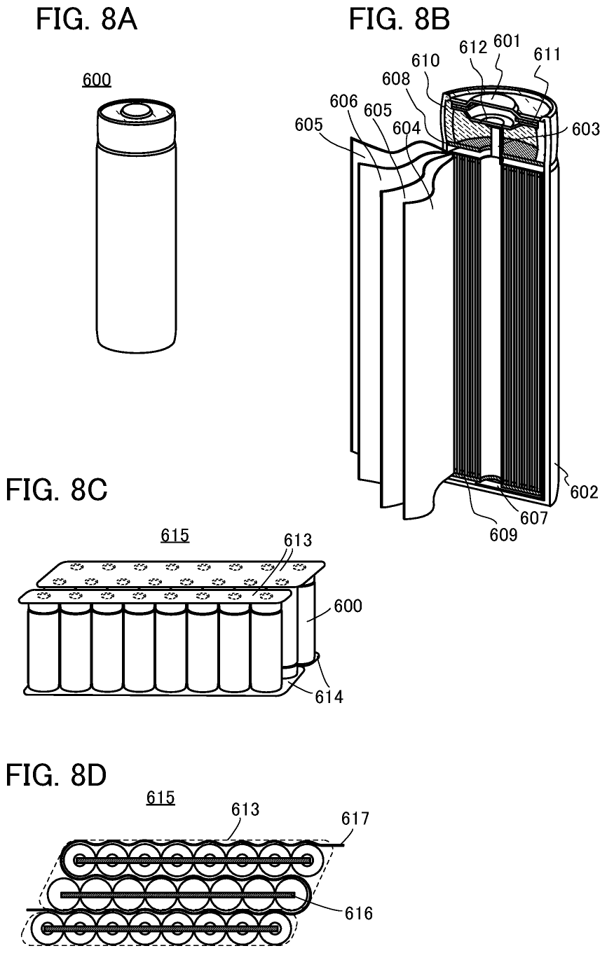

Next, an example of a cylindrical secondary battery is described with reference to FIG. 8. FIG. 8A is an external view of a cylindrical secondary battery 600. FIG. 8B is a diagram schematically illustrating a cross section of the cylindrical secondary battery 600. The cylindrical secondary battery 600 includes, as illustrated in FIG. 8B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte, such as nickel, aluminum, or titanium, an alloy of such a metal, or an alloy of such a metal and another metal (e.g., stainless steel) can be used. Alternatively, the battery can 602 is preferably covered with nickel, aluminum, and/or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

Alternatively, as shown in FIG. 8C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 8D is a top view of the module 615. The conductive plate 613 is shown by a dotted line for clarity of the diagram. As illustrated in FIG. 8D, the module 615 may include a wiring 616 electrically connecting the plurality of secondary batteries 600 to each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high capacity and excellent cycle performance can be obtained.

### <Structure Examples of Secondary Battery>

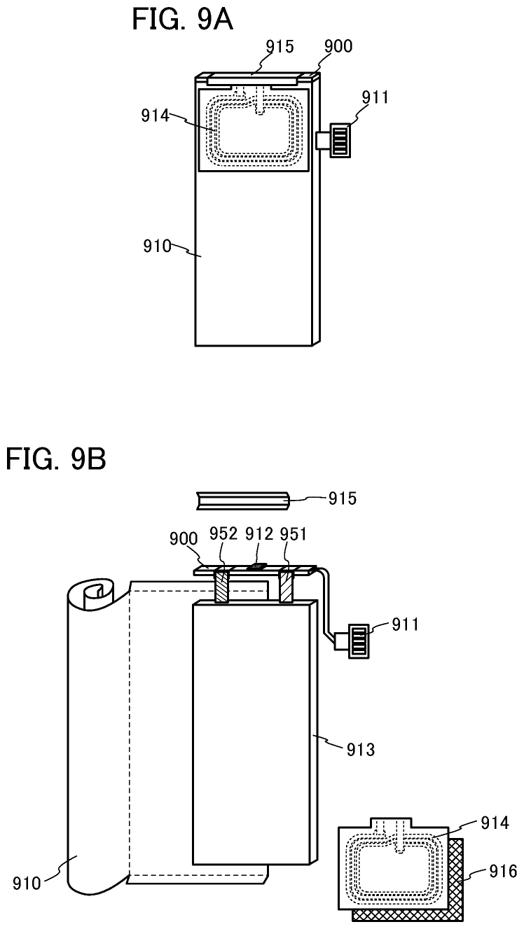

Other structure examples of a secondary battery are described using FIG. 9 to FIG. 13.

FIG. 9A and FIG. 9B are external views of a battery pack. The battery pack includes a secondary battery 913 and a circuit board 900. The secondary battery 913 is connected to an antenna 914 through the circuit board 900. A label 910 is attached to the secondary battery 913. Moreover, as illustrated in FIG. 9B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 9.

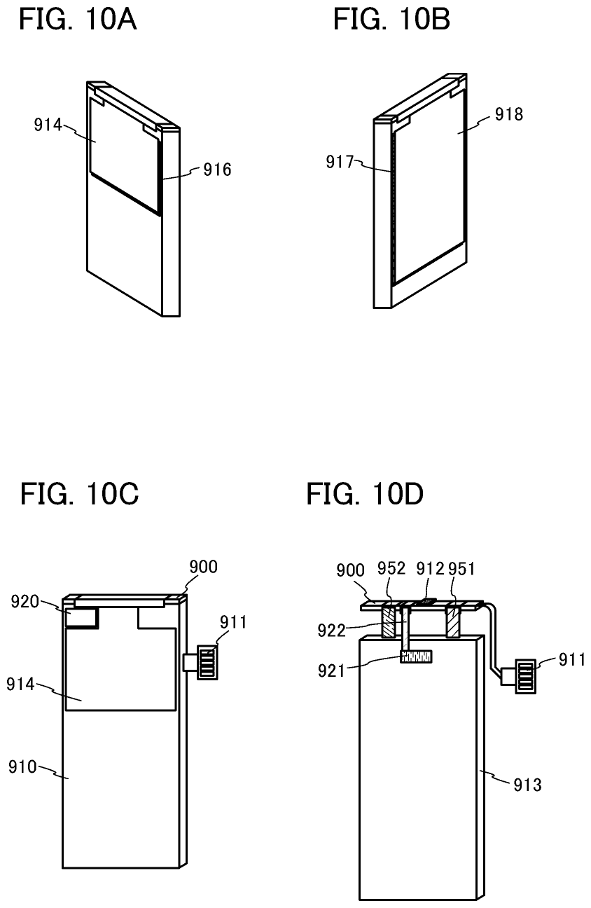

For example, as illustrated in FIG. 10A and FIG. 10B, an antenna may be provided for each of a pair of opposing surfaces of the secondary battery 913 illustrated in FIG. 9A and FIG. 9B. FIG. 10A is an external view illustrating one of the pair of surfaces, and FIG. 10B is an external view illustrating the other of the pair of surfaces. Note that for the same portions as those in the secondary battery illustrated in FIG. 9A and FIG. 9B, it is possible to refer to the description of the secondary battery illustrated in FIG. 9A and FIG. 9B as appropriate.

As illustrated in FIG. 10A, the antenna 914 is provided on one of the pair of surfaces of the secondary battery 913 with the layer 916 located therebetween, and as illustrated in FIG. 10B, an antenna 918 is provided on the other of the pair of surfaces of the secondary battery 913 with a layer 917 located therebetween. The layer 917 has a function of blocking an electromagnetic field by the secondary battery 913, for example. As the layer 917, for example, a magnetic body can be used.

With the above structure, both the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 10C, the secondary battery 913 illustrated in FIG. 9A and FIG. 9B may be provided with a display device 920. The display device 920 is electrically connected to the terminal 911. Note that the label 910 is not necessarily provided in a portion where the display device 920 is provided. Note that for the same portions as those in the secondary battery illustrated in FIG. 9A and FIG. 9B, it is possible to refer to the description of the secondary battery illustrated in FIG. 9A and FIG. 9B as appropriate.

The display device 920 may display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 10D, the secondary battery 913 illustrated in FIG. 9A and FIG. 9B may be provided with a sensor 921. The sensor 921 is electrically connected to the terminal 911 through a terminal 922. Note that for the same portions as those in the secondary battery illustrated in FIG. 9A and FIG. 9B, it is possible to refer to the description of the secondary battery illustrated in FIG. 9A and FIG. 9B as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

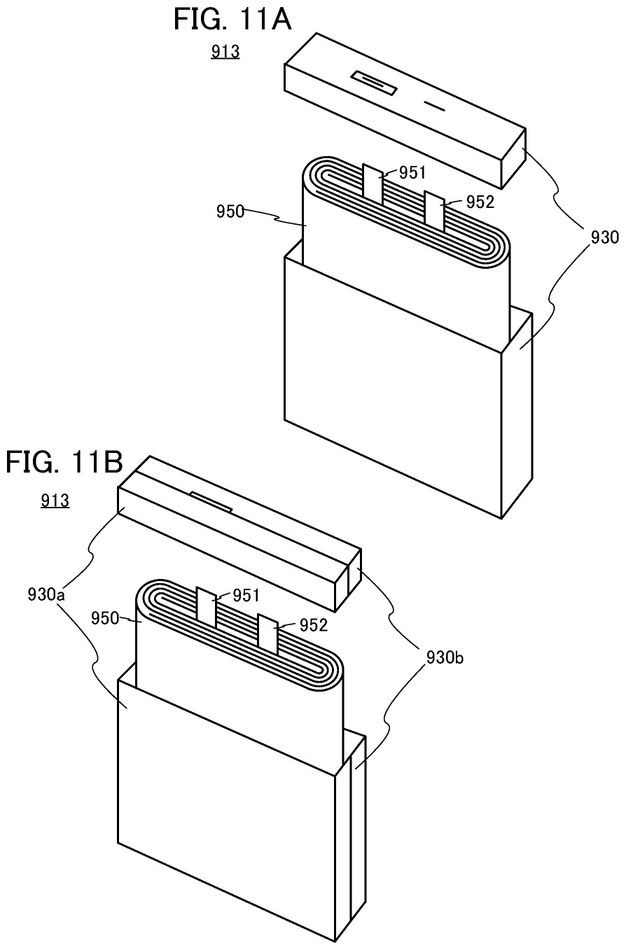

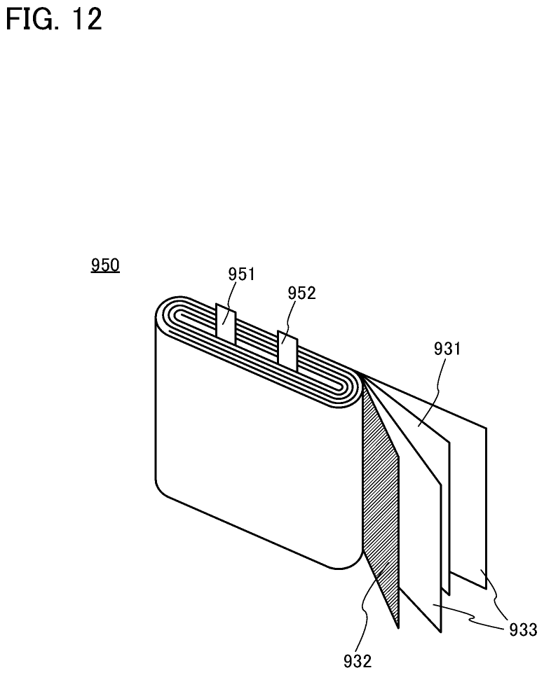

Furthermore, structure examples of the secondary battery 913 are described using FIG. 11 and FIG. 12.

The secondary battery 913 illustrated in FIG. 11A includes a wound body 950 provided with a terminal 951 and a terminal 952 inside a housing 930. The wound body 950 is soaked in an electrolyte inside the housing 930. The terminal 952 is in contact with the housing 930. The use of an insulator or the like prevents contact between the terminal 951 and the housing 930. Note that in FIG. 11A, the housing 930 divided into pieces is shown for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 11B, the housing 930 in FIG. 11A may be formed using a plurality of materials. For example, in the secondary battery 913 illustrated in FIG. 11B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 12 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

The negative electrode 931 is connected to the terminal 911 illustrated in FIG. 9 through one of the terminal 951 and the terminal 952. The positive electrode 932 is connected to the terminal 911 illustrated in FIG. 9 through the other of the terminal 951 and the terminal 952.

When the positive electrode active material described in the above embodiment is used in the positive electrode 932, the secondary battery 913 with high capacity and excellent cycle performance can be obtained.

### <Laminated Secondary Battery>

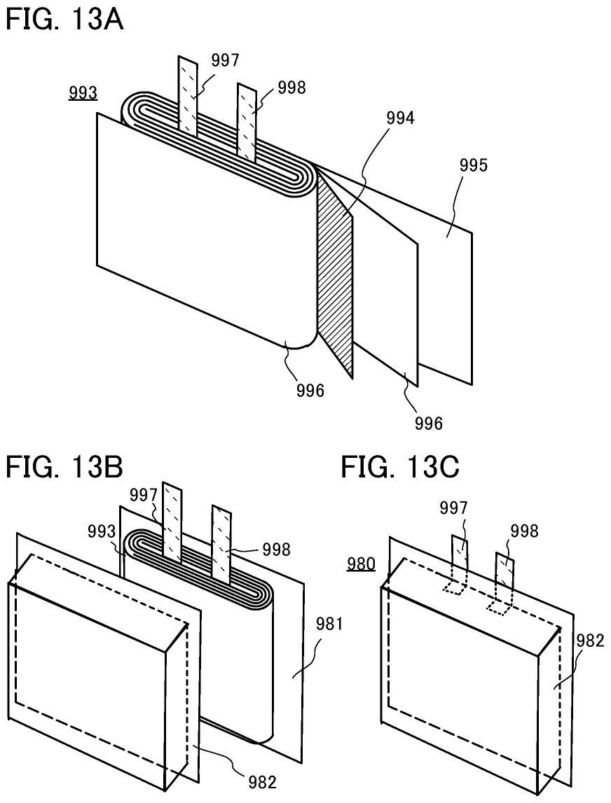

Next, an example of a laminated secondary battery is described with reference to FIG. 13 to FIG. 19. When the laminated secondary battery has flexibility, the secondary battery can be used in an electronic device at least part of which is flexible and can be bent as the electronic device is bent.

A laminated secondary battery 980 is described using FIG. 13. The laminated secondary battery 980 includes a wound body 993 illustrated in FIG. 13A. The wound body 993 includes a negative electrode 994, a positive electrode 995, and separators 996. Like the wound body 950 illustrated in FIG. 12, the wound body 993 is a wound body where the negative electrode 994 is stacked to overlap with the positive electrode 995 with the separator 996 positioned therebetween and the sheet of the stack is wound.

Note that the number of stacks each including the negative electrode 994, the positive electrode 995, and the separator 996 is designed as appropriate depending on required capacity and element volume. The negative electrode 994 is connected to a negative electrode current collector (not illustrated) through one of a lead electrode 997 and a lead electrode 998. The positive electrode 995 is connected to a positive electrode current collector (not illustrated) through the other of the lead electrode 997 and the lead electrode 998.

As illustrated in FIG. 13B, the wound body 993 is packed in a space formed through attachment of a film 981 serving as an exterior body and a film 982 having a depressed portion by thermocompression bonding or the like, whereby the secondary battery 980 illustrated in FIG. 13C can be manufactured. The wound body 993 includes the lead electrode 997 and the lead electrode 998, and is soaked in an electrolyte inside the film 981 and the film 982 having a depressed portion.

For the film 981 and the film 982 having a depressed portion, a metal material such as aluminum and/or a resin material can be used, for example. With the use of a resin material for the film 981 and the film 982 having a depressed portion, the film 981 and the film 982 having a depressed portion can be changed in their forms when external force is applied; thus, a flexible storage battery can be manufactured.

Although FIG. 13B and FIG. 13C illustrate an example of using two films, a space may be formed by bending one film and the wound body 993 may be packed in the space.

When the positive electrode active material described in the above embodiment is used in the positive electrode 995, the secondary battery 980 with high capacity and excellent cycle performance can be obtained.

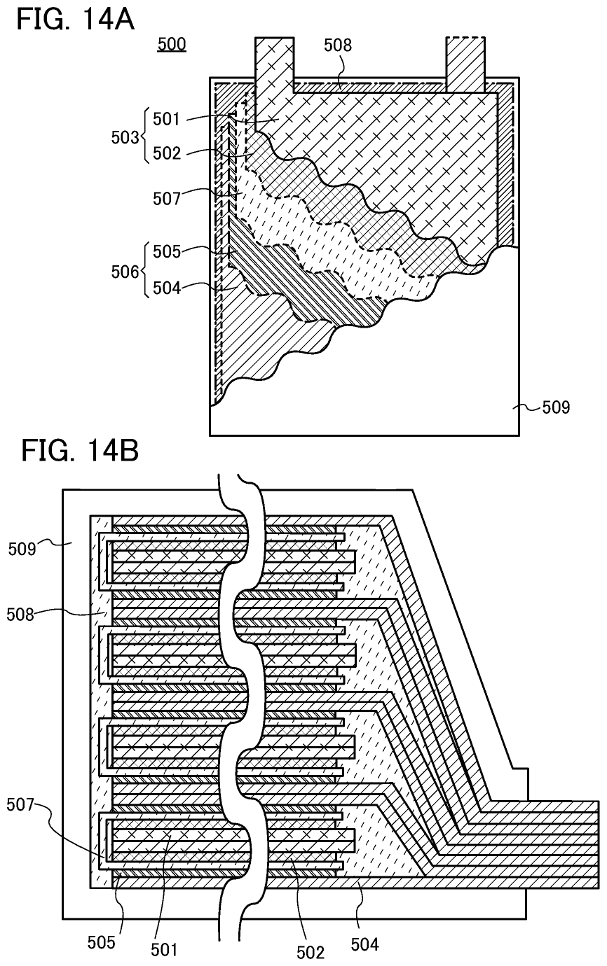

FIG. 13 illustrates an example in which the secondary battery 980 includes a wound body in a space formed by films serving as an exterior body; as illustrated in FIG. 14, for example, a secondary battery may include a plurality of strip-shaped positive electrodes, separators, and negative electrodes in a space formed by a film serving as an exterior body.

A laminated secondary battery 500 illustrated in FIG. 14A includes a positive electrode 503 including a positive electrode current collector 501 and a positive electrode active material layer 502, a negative electrode 506 including a negative electrode current collector 504 and a negative electrode active material layer 505, a separator 507, an electrolyte 508, and an exterior body 509. The separator 507 is provided between the positive electrode 503 and the negative electrode 506 in the exterior body 509. The exterior body 509 is filled with the electrolyte 508. The electrolyte described in Embodiment 3 can be used as the electrolyte 508.

In the laminated secondary battery 500 illustrated in FIG. 14A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 14B illustrates an example of a cross-sectional structure of the laminated secondary battery 500. Although FIG. 14A illustrates an example in which the laminated secondary battery 500 is composed of two current collectors for simplicity, the laminated secondary battery 500 is actually composed of a plurality of electrode layers, as illustrated in FIG. 14B.

In FIG. 14B, the number of electrode layers is 16, for example. Note that the secondary battery 500 has flexibility even though the number of electrode layers is 16. FIG. 14B illustrates a structure including 8 layers of negative electrode current collectors 504 and 8 layers of positive electrode current collectors 501, i.e., 16 layers in total. Note that FIG. 14B shows a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high capacity. In contrast, with a small number of electrode layers, the secondary battery can have small thickness and high flexibility.

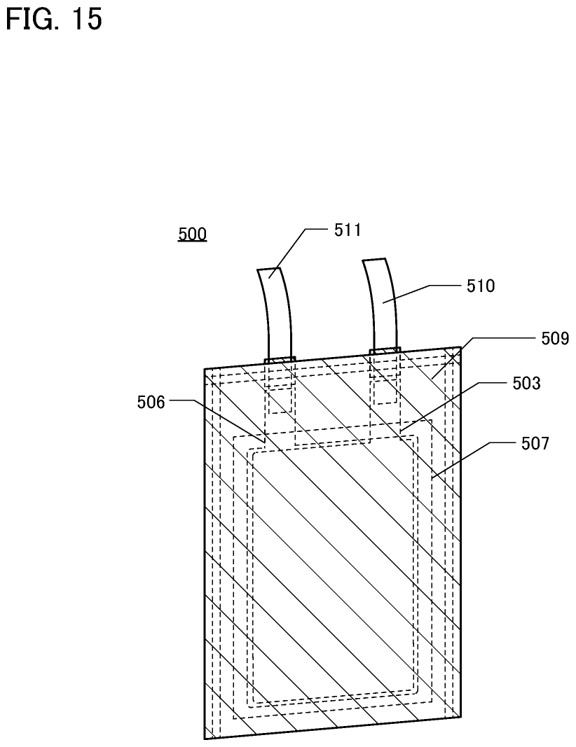

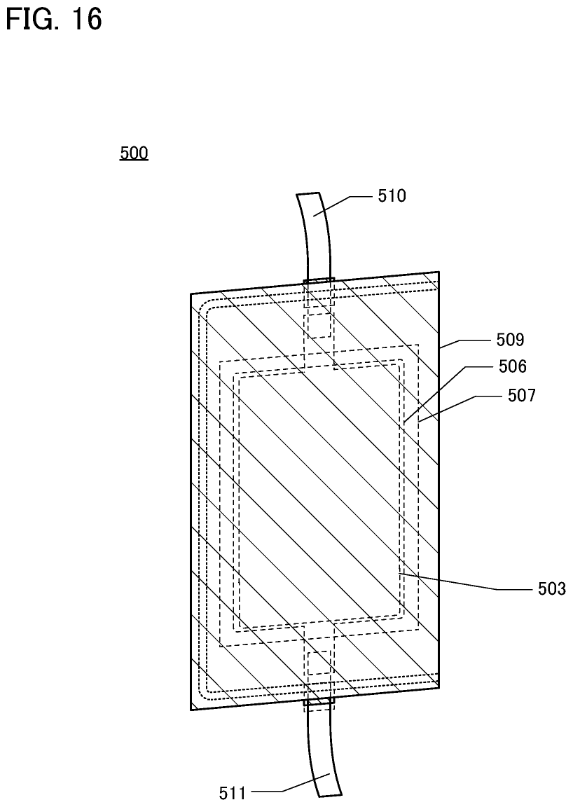

FIG. 15 and FIG. 16 each show an example of an external view of the laminated secondary battery 500. FIG. 15 and FIG. 16 each include the positive electrode 503, the negative electrode 506, the separator 507, the exterior body 509, a positive electrode lead electrode 510, and a negative electrode lead electrode 511.

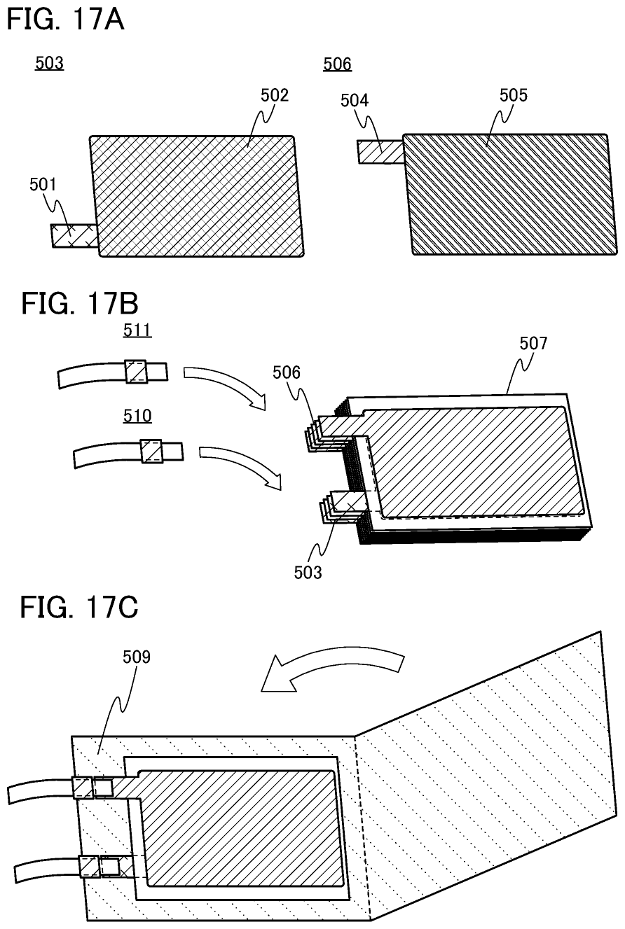

FIG. 17A shows external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and/or the shapes of the tab regions included in the positive electrode and the negative electrode are not limited to those illustrated in FIG. 17A.

### <Method for Manufacturing Laminated Secondary Battery>

Here, an example of a method for manufacturing the laminated secondary battery whose external view is shown in FIG. 15 is described using FIG. 17B and FIG. 17C.

First, the negative electrode 506, the separator 507, and the positive electrode 503 are stacked. FIG. 17B illustrates the negative electrodes 506, the separators 507, and the positive electrodes 503 that are stacked. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

Then, the negative electrodes 506, the separators 507, and the positive electrodes 503 are placed over the exterior body 509.

Subsequently, the exterior body 509 is folded along a portion shown by a dashed line, as illustrated in FIG. 17C. After that, the outer edges of the exterior body 509 are bonded to each other. The bonding can be performed by thermocompression bonding, for example. At this time, an unbonded region (hereinafter referred to as an inlet) is provided for part (or one side) of the exterior body 509 so that the electrolyte 508 can be introduced later.

Next, the electrolyte 508 (not illustrated) is introduced into the exterior body 509 from the inlet of the exterior body 509. The electrolyte 508 is preferably introduced in a reduced pressure atmosphere or in an inert atmosphere. Lastly, the inlet is bonded. In this manner, the laminated secondary battery 500 can be manufactured.

When the positive electrode active material described in the above embodiment is used in the positive electrode 503, the secondary battery 500 with high capacity and excellent cycle performance can be obtained.

### <Bendable Secondary Battery>

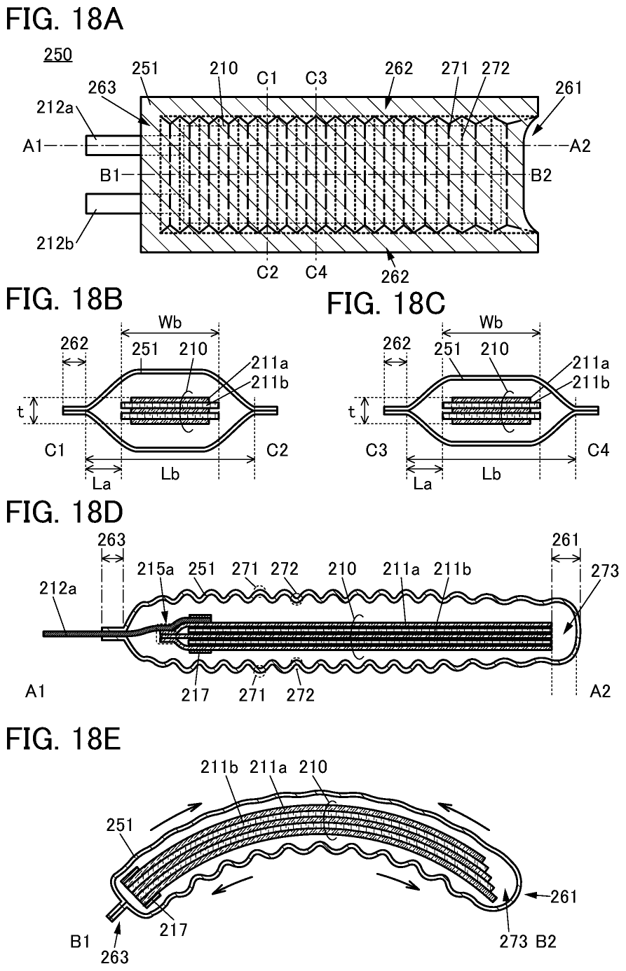

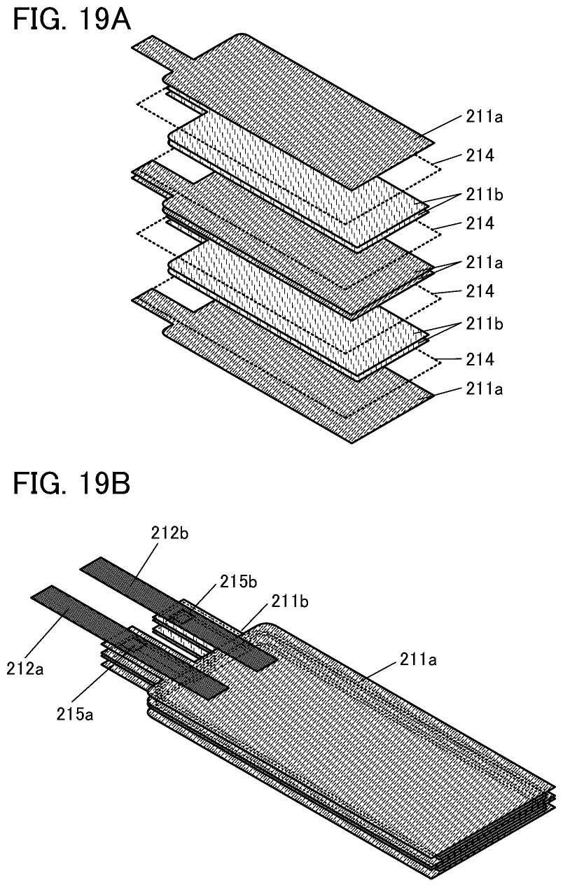

Next, an example of a bendable secondary battery is described with reference to FIG. 18 and FIG. 19.

FIG. 18A is a schematic top view of a bendable secondary battery 250. FIG. 18B, FIG. 18C, FIG. 18D, and FIG. 18E are schematic cross-sectional views along cutting line C1-C2, cutting line C3-C4, cutting line A1-A2, and cutting line B1-B2, respectively, in FIG. 18A. The secondary battery 250 includes an exterior body 251 and positive electrodes 211a and negative electrodes 211b that are held in the exterior body 251. The positive electrodes 211a and the negative electrodes 211b are collectively referred to as an electrode 210. A lead 212a electrically connected to the positive electrode 211a and a lead 212b electrically connected to the negative electrode 211b extend to the outside of the exterior body 251. In addition to the positive electrode 211a and the negative electrode 211b, an electrolyte (not illustrated) is enclosed in a region surrounded by the exterior body 251.

The positive electrode 211a and the negative electrode 211b that are included in the secondary battery 250 are described using FIG. 19. FIG. 19A is a perspective view illustrating the stacking order of the positive electrodes 211a, the negative electrodes 211b, and separators 214. FIG. 19B is a perspective view illustrating the lead 212a and the lead 212b in addition to the positive electrode 211a and the negative electrode 211b.

As illustrated in FIG. 19A, the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab. A positive electrode active material layer is formed on one surface of the positive electrode 211a other than the tab, and a negative electrode active material layer is formed on one surface of the negative electrode 211b other than the tab.

The positive electrodes 211a and the negative electrodes 211b are stacked so that surfaces of the positive electrodes 211a on each of which the positive electrode active material layer is not formed are in contact with each other and surfaces of the negative electrodes 211b on each of which the negative electrode active material layer is not formed are in contact with each other.

The separator 214 is provided between the surface of the positive electrode 211a on which the positive electrode active material layer is formed and the surface of the negative electrode 211b on which the negative electrode active material layer is formed. In FIG. 19A and FIG. 19B, the separator 214 is shown by a dotted line for easy viewing.

As illustrated in FIG. 19B, the plurality of positive electrodes 211a are electrically connected to the lead 212a in a bonding portion 215a. The plurality of negative electrodes 211b are electrically connected to the lead 212b in a bonding portion 215b.

Next, the exterior body 251 is described using FIG. 18B, FIG. 18C, FIG. 18D, and FIG. 18E.

The exterior body 251 has a film-like shape and is folded in half so as to sandwich the positive electrodes 211a and the negative electrodes 211b. The exterior body 251 includes a folded portion 261, a pair of seal portions 262, and a seal portion 263. The pair of seal portions 262 are provided with the positive electrodes 211a and the negative electrodes 211b positioned therebetween and can also be referred to as side seals. The seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. The seal portions 262 and the seal portion 263 of the exterior body 251 are preferably flat.

FIG. 18B is a cross section cut along a portion overlapping with the crest line 271. FIG. 18C is a cross section cut along a portion overlapping with the trough line 272. FIG. 18B and FIG. 18C correspond to cross sections of the secondary battery 250, the positive electrodes 211a, and the negative electrodes 211b in the width direction.

Here, the distance between end portions of the positive electrode 211a and the negative electrode 211b in the width direction and the seal portion 262, that is, the distance between the end portions of the positive electrode 211a and the negative electrode 211b and the seal portion 262 is referred to as a distance La. When the secondary battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, the metal film might be corroded by the electrolyte. Therefore, the distance La is preferably set as long as possible. However, if the distance La is too long, the volume of the secondary battery 250 is increased.

Furthermore, the distance La between the positive electrode 211a and the negative electrode 211b, and the seal portion 262 is preferably increased as the total thickness of the positive electrode 211a and the negative electrode 211b that are stacked is increased.

Specifically, when the total thickness of the stacked positive electrodes 211a, negative electrodes 211b, and separators 214 (not illustrated) is t, the distance La is preferably 0.8 times or more and 3.0 times or less, further preferably 0.9 times or more and 2.5 times or less, still further preferably 1.0 times or more and 2.0 times or less as large as the thickness t. When the distance La is in the above range, a compact battery highly reliable for bending can be obtained.

When the distance between the pair of seal portions 262 is referred to as a distance Lb, it is preferred that the distance Lb be sufficiently longer than the widths of the positive electrode 211a and the negative electrode 211b (here, a width Wb of the negative electrode 211b). In that case, even if the positive electrode 211a and the negative electrode 211b come into contact with the exterior body 251 when deformation such as repeated bending of the secondary battery 250 is conducted, parts of the positive electrode 211a and the negative electrode 211b can be shifted in the width direction; thus, the positive electrode 211a and the negative electrode 211b can be effectively prevented from being rubbed against the exterior body 251.

For example, the difference between the distance Lb, which is the distance between the pair of seal portions 262, and the width Wb of the negative electrode 211b is preferably 1.6 times or more and 6.0 times or less, further preferably 1.8 times or more and 5.0 times or less, still further preferably 2.0 times or more and 4.0 times or less as large as the thickness t of the positive electrode 211a and the negative electrode 211b.

In other words, the distance Lb, the width Wb, and the thickness t preferably satisfy the relation of Formula 1 below.

$$\begin{matrix}[ Formula 1 ] & \\ \frac{Lb - W b}{2 t} \geq a & ( Formula 1 )\end{matrix}$$

Here, a satisfies 0.8 or more and 3.0 or less, preferably 0.9 or more and 2.5 or less, further preferably 1.0 or more and 2.0 or less.

FIG. 18D is a cross section including the lead 212a and corresponds to a cross section of the secondary battery 250, the positive electrode 211a, and the negative electrode 211b in the length direction. As illustrated in FIG. 18D, in the bent portion 261, a space 273 is preferably included between the end portions of the positive electrode 211a and the negative electrode 211b in the length direction and the exterior body 251.

FIG. 18E is a schematic cross-sectional view when the secondary battery 250 is bent. FIG. 18E corresponds to a cross section along cutting line B1-B2 in FIG. 18A.

When the secondary battery 250 is bent, a part of the exterior body 251 positioned on the outer side in bending is unbent and the other part positioned on the inner side changes its shape as it shrinks. More specifically, the part of the exterior body 251 positioned on the outer side changes its shape such that the wave amplitude becomes smaller and the length of the wave period becomes larger. In contrast, the part of the exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself of the exterior body 251 does not need to expand or contract. Thus, the secondary battery 250 can be bent with weak force without damage to the exterior body 251.

Furthermore, as illustrated in FIG. 18E, when the secondary battery 250 is bent, the positive electrode 211a and the negative electrode 211b are shifted relatively to each other. At this time, ends of the stacked positive electrodes 211a and negative electrodes 211b on the seal portion 263 side are fixed by a fixing member 217. Thus, the positive electrodes 211a and the negative electrodes 211b are shifted so that the shift amount becomes larger at a position closer to the bent portion 261. Therefore, stress applied to the positive electrode 211a and the negative electrode 211b is relieved, and the positive electrode 211a and the negative electrode 211b themselves do not need to expand or contract. Consequently, the secondary battery 250 can be bent without damage to the positive electrode 211a and the negative electrode 211b.

The space 273 is included between the positive electrode 211a and the negative electrode 211b, and the exterior body 251, whereby the positive electrode 211a and the negative electrode 211b can be shifted relatively while the positive electrode 211a and the negative electrode 211b located on the inner side in bending do not come into contact with the exterior body 251.

In the secondary battery 250 illustrated in FIG. 18 and FIG. 19, damage to the exterior body, damage to the positive electrode 211a and the negative electrode 211b, and the like are less likely to occur and the battery performance is less likely to deteriorate even when the secondary battery 250 is repeatedly bent and stretched. When the positive electrode active material described in the above embodiment is used in the positive electrode 211a included in the secondary battery 250, a battery with better cycle performance can be obtained.

In an all-solid-state battery, the contact state of the inside interfaces can be kept favorable by applying a predetermined pressure in the direction of stacking positive electrodes and/or negative electrodes. By applying a predetermined pressure in the direction of stacking the positive electrodes and/or the negative electrodes, expansion in the stacking direction due to charge and discharge of the all-solid-state battery can be suppressed, and the reliability of the all-solid-state battery can be improved.

This embodiment can be used in appropriate combination with any of the other embodiments.

### Embodiment 5

In this embodiment, examples of electronic devices each including the secondary battery of one embodiment of the present invention are described.

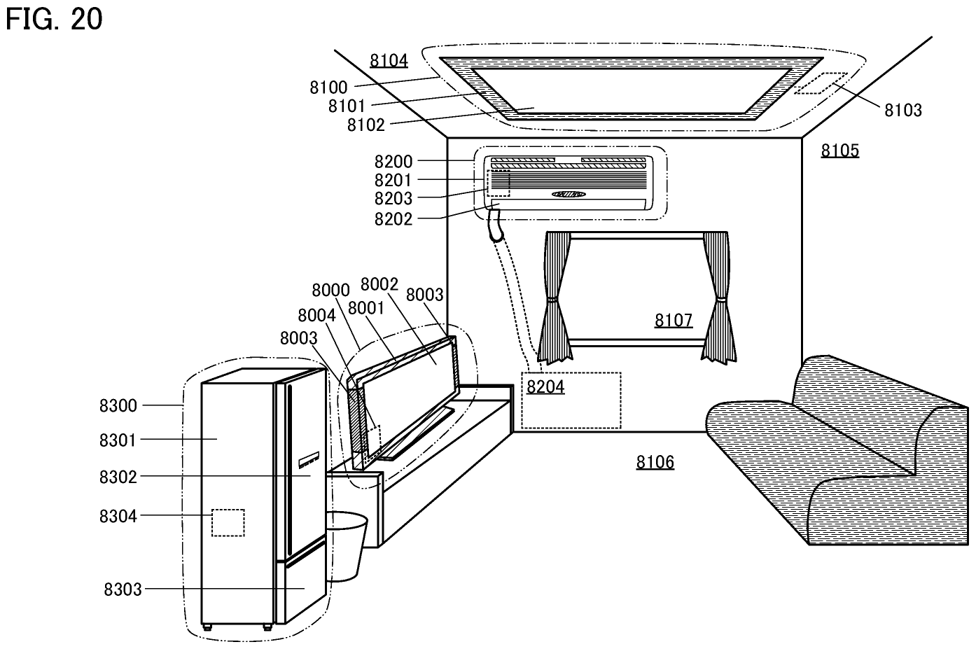

FIG. 20 illustrates examples of electronic devices. In FIG. 20, a display device 8000 is an example of an electronic device using a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 20, an installation lighting device 8100 is an example of an electronic device using a secondary battery 8103 of one embodiment of the present invention. Specifically, the lighting device 8100 includes a housing 8101, a light source 8102, the secondary battery 8103, and the like. Although FIG. 20 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 20 as an example, the secondary battery of one embodiment of the present invention can be used in an installation lighting device provided in, for example, a sidewall 8105, a floor 8106, a window 8107, or the like other than the ceiling 8104. The secondary battery can also be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and/or an organic EL element are given as examples of the artificial light source.

In FIG. 20, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 20 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 20 as an example, the secondary battery of one embodiment of the present invention can also be used in an air conditioner in which the functions of an indoor unit and an outdoor unit are integrated in one housing.

In FIG. 20, an electric refrigerator-freezer 8300 is an example of an electronic device using a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 20. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Accordingly, the tripping of a breaker of a commercial power supply in use of the electronic device can be prevented by using the secondary battery of one embodiment of the present invention as an auxiliary power supply for supplying electric power that cannot be supplied enough by a commercial power supply.

In a time period when electronic devices are not used, particularly when the proportion of the amount of electric power that is actually used to the total amount of electric power that can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the ambient temperature is low and the refrigerator door 8302 and the freezer door 8303 are not opened or closed. Moreover, in daytime when the ambient temperature rises and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with any of the other embodiments.

### Embodiment 6

In this embodiment, examples of vehicles each including the secondary battery of one embodiment of the present invention are described.

The use of secondary batteries in vehicles enables production of next-generation clean energy vehicles such as hybrid electric vehicles (HVs), electric vehicles (EVs), and plug-in hybrid electric vehicles (PHVs).

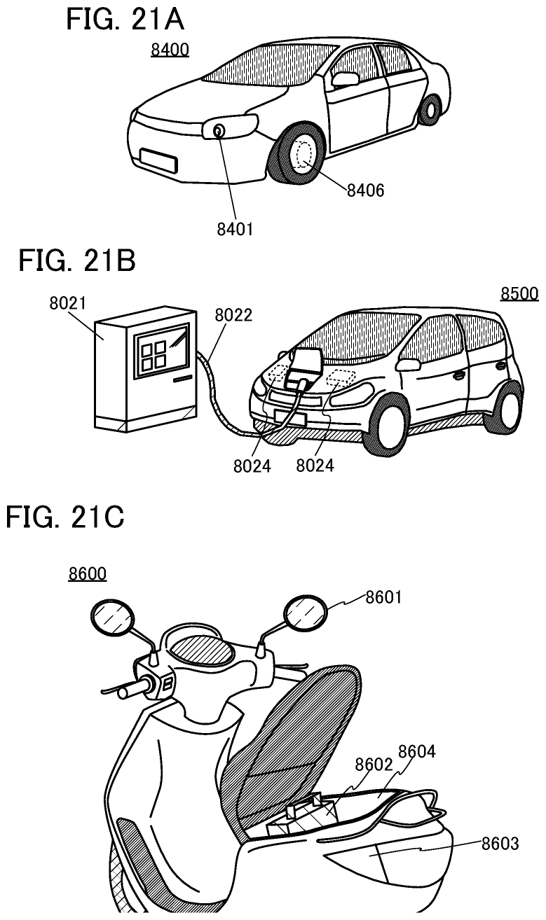

FIG. 21 illustrates examples of vehicles using the secondary battery of one embodiment of the present invention. An automobile 8400 illustrated in FIG. 21A is an electric vehicle that runs on the power of an electric motor as a power source. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. As the secondary battery, the secondary battery modules illustrated in FIG. 8C and FIG. 8D can be arranged to be used in a floor portion in the automobile. Alternatively, a battery pack in which a plurality of secondary batteries illustrated in FIG. 11 are combined may be placed in the floor portion in the automobile. The secondary battery can be used not only for driving an electric motor 8406, but also for supplying electric power to a light-emitting device such as a headlight 8401 or a room light (not illustrated).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 21B can be charged when the secondary battery included in the automobile 8500 is supplied with electric power through external charge equipment by a plug-in system, a contactless power feeding system, or the like. FIG. 21B illustrates a state where a secondary battery 8024 incorporated in the automobile 8500 is charged from a ground-based charging device 8021 through a cable 8022. Charging can be performed as appropriate by a given method such as CHAdeMO (registered trademark) or Combined Charging System as a charging method, the standard of a connector, or the like. The charging device 8021 may be a charge station provided in a commerce facility or a power supply in a house. For example, with the use of a plug-in technique, the secondary battery 8024 included in the automobile 8500 can be charged by being supplied with electric power from outside. The charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle stops but also when moves. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 21C shows an example of a motorcycle using the secondary battery of one embodiment of the present invention. A motor scooter 8600 illustrated in FIG. 21C includes a secondary battery 8602, side mirrors 8601, and direction indicators 8603. The secondary battery 8602 can supply electric power to the direction indicators 8603.

In the motor scooter 8600 illustrated in FIG. 21C, the secondary battery 8602 can be stored in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the any of other embodiments.

### REFERENCE NUMERALS

100: positive electrode active material, 200: active material layer, 201: graphene compound, 803: lithium compound, 804: phosphorus compound, 805: solvent, 806: lithium-containing solution, 807: phosphorus-containing solution, 811: mixture, 812: solution P, 813: solution containing transition metal M, 821: mixture, 822: transition metal M source, 823: mixture, 831: mixture

1. A method for manufacturing a positive electrode active material including lithium and a transition metal, comprising:
a first step of preparing a lithium compound, a phosphorus compound, and water;
a second step of forming a first mixture by mixing the lithium compound, the phosphorus compound, and the water;
a third step of forming a second mixture by adding a first aqueous solution to the first mixture to adjust a pH;
a fourth step of forming a third mixture by mixing an iron(II) compound with the second mixture;
a fifth step of forming a fourth mixture by heating the third mixture; and
a sixth step of obtaining a positive electrode active material by filtering, washing, and drying the fourth mixture,
wherein in the first step, a material having a purity higher than or equal to 99.99% is prepared as the lithium compound, a material having a purity higher than or equal to 99% is prepared as the phosphorus compound, and pure water having a resistivity higher than or equal to 15 MΩ·cm is prepared as the water,
wherein in the fourth step, a material having a purity higher than or equal to 99.9% is used as the iron(II) compound,
wherein in the fourth step, a pH of the third mixture is greater than or equal to 3.5 and less than or equal to 5.0, and
wherein the heating in the fifth step is performed under a pressure higher than or equal to 0.11 MPa and lower than or equal to 2 MPa at a temperature higher than or equal to 150° C. and lower than or equal to 250° C. for longer than or equal to 1 hour and shorter than or equal to 10 hours.

2. The method for manufacturing a positive electrode active material, according to claim 1,
wherein lithium chloride is used as the lithium compound, phosphoric acid is used as the phosphorus compound, and iron(II) chloride tetrahydrate is used as the iron(II) compound.

3. The method for manufacturing a positive electrode active material, according to claim 1,
wherein pure water having a resistivity higher than or equal to 15 MΩ·cm is used for the washing.

4. A secondary battery comprising:
a composite oxide comprising:
a single crystal grain comprising lithium, iron, phosphorus, and oxygen; and
a graphene compound.

5. A vehicle comprising the secondary battery according to claim 4.
